(19) United States
(12) Patent Application Publication
(10) Pub. No.: US 2005/0177416 A1
(43) Pub. Date: Aug. 11, 2005

(54) Mobile advertising methods and improvements

(76) Inventor: Craig L Linden, Alpine, CA (US)

Correspondence Address: Craig L Linden, 1335 Midway Drive, Alpine, CA, 91901, US

(21) Appl. No.: 10/469,800

(22) PCT Filed: Dec. 9, 2000
(86) PCT No.: PCT/US00/42771

Related U.S. Application Data
(60) Provisional application No. 60/170,088, filed on Dec. 9, 1999.

(51) Int. Cl. G06F 17/60

(52) U.S. Cl. 705/14

(57) ABSTRACT

Mobile advertising methods and improvements, for instance, the adding of global positioning satellite tracking devices to mobile advertising platforms for purposes of verification of location, travel routes, mileage, etc. Incorporation of the Internet, Intranet, peer-to-peer and/or other networking systems and associated software for improving business methods, account access, and the interface between the advertiser or client, the ad agency or administration, and those persons or entities associated with the mobile platforms. Providing wireless communication systems for mobile advertising platforms for enabling real-time messages and for real-time interaction and/or for connecting central or distributed service operations. Providing improved compensation particularity to those persons or entities associated most closely with the mobile platforms. Incorporation of video and/or still e-cameras and/or audio equipment into the mobile advertising platform.

### CROSS-REFERENCES TO RELATED APPLICATIONS

This application claims the benefit of U.S. Provisional Patent Application Ser. No. 60/170,088, filed 9 Dec. 99, on behalf of Craig L. Linden and titled AD-DRIVE. Additionally, U.S. Patent Office Disclosure Documents Nos. 467551 and 471830, were respectively mailed on Jan. 1, 2000 and Mar. 24, 2000, and they now carry the respective USPTO date stamp markings of Jan. 11, 2000, and Apr. 3, 2000.

### BACKGROUND

1. Field of Invention

This invention relates generally to new or improved methods relating to advertising on mobile platform mobile advertising and mobile information business and methods (together, herein meaning “advertising”, “advertisements”, “ads” or “adverts”). The word “method” herein will generally be used in place of one or more of the following terms: advertising services, business services, business concepts, mobile advertising processes, business method, business model, etc. These improvements and new methods are accomplished through the inventive integration and/or mixing and matching of various new and existing mobile platforms, the Internet, software, wireless devices, incentives, compensation, communication systems, location technology such as GPS, and methods and/or by the inventive overcoming of serious limitations related to the prior art of mobile advertising. Although this application will primarily apply to mobile advertising platforms, other platforms and methods are included when the inventive combinations and/or new methods herein proposed are applicable.

2. Description of Prior Art

Although not so limited, this invention generally relates to mobile platforms used for advertising, such as automobiles (herein, the word “car” may refer to vehicles, trucks, motorcycles, scooters, etc.) boats, planes, bikes, skateboards, signs, phones, PDAs, game and gaming platforms, appliances, computers, living beings, articles of clothing, toys, etc. (these and other related mobile platforms, herein may be referred to as simply “mobile platforms”). Examples of prior art are taxi and bus ads, signs on company owned cars, airplanes pulling ad banners, bumper stickers, license plate frames, dealership logos, race and other cars with sponsorship ads, hats, clothing, etc. These examples represent three common financial models of mobile platform advertising: a. volunteer, i.e., wearing your favorite baseball team's cap, branded shoes, a civic ad (“give blood”, etc.) on a tee shirt, etc.; b. sponsored ads, i.e., race cars, etc.; c. paid mobile platform advertising, i.e., taxi ads, moving billboards, etc.

A paid example that will be used herein, is commuter cars whose owners contract with advertising firms, etc. to use their car as a mobile advertising platform in exchange for significant valuable compensation. The general concept of actually paying money to car owners for placing advertisements on their cars may not be new. Reportedly, starting in 1972, a company named Beetleboards paid VW bug car owners about $20 USD per month to place advertising on their Volkswagen cars. In addition to the low monetary compensation, the VW bug owners apparently also benefited from an exclusive “bug club” or Beetleboard membership effect that encouraged them to sport the third partly advertising arranged by the Beetleboard’ company. Apparently, the belonging to the bug ad club effect did not spread to other makes of cars. As the popularity of owning VW bugs died off so did the Beetleboard advertising business.

Herein, the “prior art” means, the prior art, prior to the inventor's press publications, related articles, Website and his provisional patent filing. Although not intended to list all the disadvantages related to the prior art, generally the prior art advertising methods and/or platforms present one or more of the following disadvantages or limitations: a) low or too little monetary or other compensation to the platform owner, i.e., “free” bumper stickers, printed tee shirts, antenna balls, hats, etc.; b) no tracking of the amount of public exposure (herein may mean the target audience, etc.) i.e., a bumper sticker could be removed within hours or days, and a tee shirt may never be worn, and a taxi could be in the shop for repairs, etc.; c) no location tracking for mobile platforms, i.e., lack of GPS, etc., enabled mobile platforms; d) limited real-time interactive advertising; e) no or limited automatic inventory and/or automatic and/or interactive replacement ordering platforms or systems; f) no or limited live or real-time updates and live or down loadable changes to the ad copy; g) mostly visual ads; h) limited video and streaming video; i) a very limited variety of platforms; j) no interactive shopping handheld or basket attached PDAs to provide in store or in mall or in car specials, ads, suggestions, recipes, reminders for additional related items, etc.; k) no or limited use of RF and IR technologies; l) no physical interaction technology; m) no or limited artificial intelligence (“AI”) technology used; n) little or no instant public or target audience feedback to the advertising message; o) limited to the use of two of the five human senses.

### SUMMARY

In accordance with the present invention, improvements, various methods and various combinations of apparatus and/or technology for mobile advertising are disclosed. Herein, the proposed improvements, combination of improvements, various methods, models, concepts and combinations of such and combinations of apparatus and/or technology, may be referred to simply as “methods”.

### OBJECTS AND ADVANTAGES

Although not so limited the general object of the present invention is to propose new and improved methods related to the mobile advertising business. The proposed methods herein may be applied to a large variety of platforms.

It is accordingly another object of the present invention to provide GPS or other available technology for tracking the movement, location, speed, and/or other parameters of the associated mobile platform. For example only, an advertising car equipped with a GPS device, which may or may not provide for real-time data to a remote location, and/or which may or may not have an onboard data recorder. GPS data may be used in any number of ways (on an update or real-time basis), such as verification of routes, mileage driven, times when driven, parking, platform and/or personal security, providing location specific ads and/or coupons (e-coupons or printed), traffic updates, emergency or police vehicle safety warnings, family location updates, spot weather, alternate routes, accidents, matchmaking or similar interest information regarding other mobile or stationary persons, etc.

Note that the ad car (herein, it should not be necessarily assumed that an ad car, or any other mobile platform, has a visual display, i.e., a platform may be instead or also be equipped with streaming or providing down loadable data related to one or more of the other senses) platform illustrates only one of many mobile platforms that may be equipped with such tracking devices, e.g., even a human ad platform may be so equipped.

Another object of the present invention is to provide one or multiple interactive methods and devices for presenting advertising messages to a plurality of persons. One example of such interactive messaging would be an ad car equipped with one or more radio-type (“RF”) or other transceiving device(s) so that other drivers (or other persons) for instance, may request additional and/or basic information from the ad car. The ad car or other platform may contain a network server computer or such server may be a convention Internet server, etc. Herein “media” refers to various types of advertising media, which may include one or more of the known and even future media, such as audio, visual, taste, smell, touch, electronic stimulation, etc. Another object is to provide mobile platforms with live streaming or real-time up-datable media displays by equipping the platforms with at least one-way receivers or two-way data, etc. transceivers. Of course any combination of technologies may be applied to any appropriate platform, i.e., GPS and digital or analog receivers or transceivers (herein, “receivers” and “transceivers” may be referred to, as simply “transceivers” or “RF”). And herein, “RF” may act as a catchall for various types of communication technologies when such are more appropriate, such as infrared “IR” or other technologies.

Please note that herein, “displays” mean whatever single or multiple technologies and devices necessary to deliver the desired type of media. Therefore, herein “display” (the word “herein” is used throughout this application to mean something mentioned within this application, i.e., not within just the associated paragraph) may refer to one or more or a combination or integration of devices/technologies, for example only, which may be represented by any type of electronic visual display, audio display, smell, taste, interactive touch devices and other technologies.

Another object is to provide a comprehensive mobile advertising method that combines the advantages of the stationary and/or mobile versions Internet, Intranet, peer-to-peer networking and/or other such systems with the one or more of the platforms, devices and/or technologies set forth herein.

Yet another object is to provide new and/or improved and/or otherwise fully adequate compensation to the persons or entities (herein, referred to as “persons”, regardless of the type of entity) to ensure sufficient interest from a sufficient number of persons, in any and all desired target areas, to produce a reasonable profit by the mobile advertising organization, etc. As noted above, lack of proper levels of compensation (herein, “compensation” may be any single thing or combination of such things as, for example only, money, cars, insurance, fuel, mortgage or other payments, food, entertainment, college tuition/expenses, travel, lodging, homes, psychological interest, etc.) is one reason the prior art VW bug based advertising venture failed.

Another object is providing methods for making sure that the above mentioned compensation properly fit the degree of performance and level of platform advertising. This of course also goes to the methods herein mentioned regarding verification of various parameters. The value of such compensation might be based upon one or more of many different factors for example only: when the ad is displayed on a private automobile, the level of compensation could be related to the number of miles, the demographics of the area and its population, traffic counts, where and how long the vehicle is parked, the time of day, the status of the owner, the type, size, age, value and/or appearance of the vehicle and associated media and other characteristics of the ads/signs/sounds/motions/displays, etc. The verification techniques are also very important to assure the client (advertiser) that their money is being well spent.

The overall object is to provide a mix of devices, platforms, compensation or compensation packages, technologies, communication systems, electronic or other networking, etc. from which a business person may select the appropriate ingredients necessary for producing a mobile platform advertising method success in any desired market for any desired product or service, etc. The long-term success of a citywide, national or globally replicable method must offer appropriate levels of compensation to the platform persons, reasonable profit levels to the mobile advertising agency or entity, while providing verifiable results, proof of advertising coverage, and/or appropriate impression data to the client or sponsor.

While another object is to provide, when desired, methods for mobile tag advertising. For example only, an ad car may on one hand be covered or otherwise present a client's message, while also carrying or presenting, via any desired media, a tag ad for the ad agency or perhaps just an URL for signing up possible new ad car or other platform persons.

It is still further an object of the present invention to provide, when desired (herein, one or more improvements, objects, methods, etc. may be selected and used singularly or in combination with other improvements, etc., and/or with other mobile or stationary advertising methods not mentioned herein) instant and/or delayed methods for providing information, input from and/or other interaction and/or ordering of products or services by the target or otherwise end user. For an example, the platform may be equipped with either physical, RF or other input/our means adaptable to serve the above mentioned purposes.

Another object is to provide new space for advertising, i.e., at the time the inventor invented these methods, etc., he was unaware of any compensated advertising programs particularly for mobile platforms controlled, used, driven, owned, rented or leased by private persons, let alone any which included the methods set forth herein. Another object is to provide part or full time employment and/or independent contractor, etc. opportunities for literally millions of persons, who otherwise would not have the chance to enter into one or more functional, creative, administrative areas of the advertising field.

Yet further object is to provide a lower cost method of advertising. For example companies currently paid for taxi, bus, billboard, raid, TV, computer, or even purchase special vehicles and provide paid drivers, insurance, fuel, etc. to display their ads. The purchase or dedication of owned or leased vehicles or the lease of space on taxies, buses, benches, etc. is relatively expensive as compared to the new methods described above.

Another object is the optional use/incorporation of the mobile and/or stationary point-of-sale and/or business sign-up and/or information connectivity terminals, making the advertising more effective by allowing the subjects more instance access (while the ads are in their thoughts and/or sight, etc.). Another object or advantage is that some of these methods bring advertising closer to the person-to-person level or word-of-mouth effect. For example, when one sees a private citizen driving their car with an ad, one may assume that person believes in the product or service being advertised (i.e., more than believing in an ad on a taxi or bus, for instance). Alternatively, or additionally, people could purchase a franchise or otherwise be provided a business license for one or more of these business methods—or they may just decide to contract to add an ad to their car, scooter, hat, etc.

Another object and/or advantage is to provide more advertising opportunities in situations and areas that have little coverage currently. For example in stop and go traffic one is limited to how many taxis or bus ads one is exposed. In a shopping mall in the near future one will see more persons sporting compensated advertising of various wearable media.

These as well as additional methods, objects and advantages will become more fully apparent from consideration of the claims.

### DESCRIPTION OF THE DRAWING

FIG. 1 is a combination pictorial and block diagram representing the wireless exchange of information. FIG. 1 represents an advertising vehicle that may carry, display and/or transmit various forms of advertising media. In one type of preferred embodiment, the vehicle might be fully equipped with an onboard computer, wireless communication system(s), video and/or still camera(s), GPS device, live or up dateable displays (and/or fixed signage of some type) and even a short distance radio transmitter for opt-in audio ads delivered to other motorists, etc. FIG. 2 represents a GPS satellite, from which the vehicle in FIG. 1 calculates its location and other information. FIG. 3 represents, for example only, a cellular type communication system and the Internet. FIG. 4 represents the server, monitor and workstation at the regional mobile advertising agency. FIG. 5 represents one or more desktop computers or handheld computers that might be in use at any time by the public to access sales and sign up information, by the advertiser or client for account information, and/or by the persons in control of the mobile platform, i.e., the car in FIG. 1.

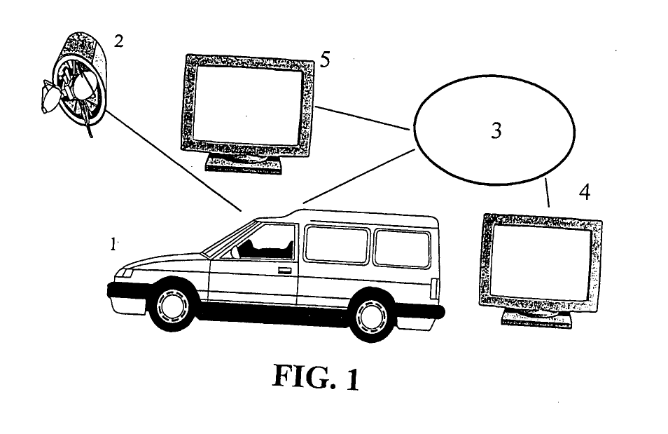

The foregoing descriptions of specific and suggested embodiments of the present invention have been presented for purposes of illustration and description only. The embodiments were chosen, drawn and described in order to best explain and illustrate, in an economical manner, the basic improvements of the invention and at least one of its practical applications. Many known and common platforms may be adapted or integrated with the present invention. Illustrations of common mobile advertising platforms without the added methods, technology, and devices discussed herein, are available elsewhere therefore, the preparation of additional drawings showing more examples has been avoided.

This document is meant to be read and understood as a whole, thereby if some descriptive point or other information is presented in one area but not another, such information and descriptions are to be applied generally as appropriate to other discussions and descriptions. The necessary components, materials and software to enable any and all of the proposed methods are available. Thereby, with the such available building blocks, along with wise and experienced electronics, mobile communications systems, GPS, advertising, marketing, finance, appropriate business knowledge, and the descriptions herein, enabling those skilled in these arts to best utilize the inventive methods and various embodiments with various modifications as are suited to the particular platform use, area and markets contemplated. Accordingly, the scope of the invention is defined by the claims appended hereto and their equivalents.

1. Improved method of advertising via non-common carrier automobiles by providing adequate compensation to the persons or entities associated with the vehicles,
whereby for example only, ideally a person or person and car, etc., in a desired target market, which also conforms with possible other client/sponsor or agency desired parameters, might list him/herself as available, might request, be requested, or might even bid to contract to provide advertising via their vehicle, and in exchange receive adequate compensation in one or more forms.

2. Improved method of advertising via automobiles by providing an onboard or portable location device, such as a GPS device,
whereby for example only, a global positioning satellite system device (“GPS” device) might either communicate various related data in real-time and/or record such data for down loading periodically.

3. Improved method of advertising via automobiles by providing one or more onboard or portable wireless communication systems or devices for improved up-dating of the ad message, spot location advertising, and for other communication purposes,
whereby for example only, such wireless device may be used to update, on a real-time, live or down loadable basis, the advertising media or other information in order to for instance change to a new ad as the vehicle approaches a client's store, or for instance to issue a warning to other drivers of an accident ahead, and such communication system may be integrated or not integrated or associated with the GPS system.

4. Improved method of advertising via automobiles by providing an Internet, Intranet, peer-to-peer, or other networking and software systems, as an significant communication and business interface between the ad agency and the persons associated with the vehicles,
whereby for example only, a comprehensive business tool consisting of computer hardware, mobile and stationary devices and appropriate software so that, for instance persons interested in signing up as potential ad drivers may review criteria, contracts and other information, potential clients may review advertising plans and rates, and data from various sources may be entered, such as when the car is fueled and the GPS data, payments, etc., and established clients and ad drivers may access their accounts.

5. Improved method of advertising via automobiles by providing one or more onboard or portable video or still cameras, with or without an audio pickup,
whereby for example only, such camera captured data may be recorded and stored and/or be transmitted in real-time or by streaming video for various purposes, for instance traffic updates, accidents, and route, parking, delivery/location verification, special events, etc.

6. A comprehensive method of advertising via automobiles, the method comprising the following steps:
a) providing adequate compensation to the person associated with the vehicle;
b) providing an onboard or portable vehicle location device.

7. A comprehensive method of advertising via automobiles, the method comprising the following steps:
a) providing adequate compensation to the person associated with the vehicle;
b) providing the Internet, Intranet, or other such networking system as a communication and/or business interface between the ad agency and persons.

8. A comprehensive system regarding the business methods of providing advertising via automobiles, the methods comprising the following steps:
a) providing the Internet, Intranet, or other networking system as a communication and/or business interface between the ad agency and persons.
b) providing adequate compensation to the person associated with the vehicle.

9. Improved method of advertising via mobile platforms by providing adequate compensation to the person associated with the platform,
whereby for example only, ideally a person or person carried platform, etc., in a desired target market, whom/which also conforms with other client/sponsor or agency desired parameters, might list him/herself as available, might request, be requested, or might even bid to contract to provide advertising via their body or personally carried platform, and in exchange receive adequate compensation in one or more forms.

10. Improved method of advertising via mobile platforms, by providing an onboard or portable location device,
whereby for example only, said location device, such as a global positioning satellite system device (“GPS” device) might either communicate various related data in real-time and/or record such data for down-loading periodically.

11. Improved method of advertising via mobile platforms by providing one or more wireless communication systems or devices,
whereby for example only, such wireless device may be used to update, on a real-time, streaming or down loadable basis, the advertising media or other information in order to, for instance, change ad copy/messages as the mobile platform approaches a client's store, or for instance, to issue a warning to others of some hazard, and such communication system may be integrated or not integrated or associated with other systems.

12. Improved method of advertising via mobile platforms, by providing the Internet, Intranet, peer-to-peer or other networking and software systems as an significant communication and business interface between the ad agency and persons,
whereby for example only, a comprehensive business tool consisting of computer hardware, mobile and stationary devices and appropriate software so that, for instance, persons interested in signing up as potential mobile platform carriers, etc., may review criteria, contracts and other information, potential clients may review advertising plans and rates, and data from various sources may be entered, such as when the platform is delivering its message, GPS data, payments, etc., and established clients and ad persons may gain access to their private access account information, etc.

13. Improved method of advertising via mobile platforms, by providing one or more onboard or video and/or still cameras, with or without an audio pickup,
whereby for example only, such camera captured data may be recorded and stored and/or be transmitted in real-time or by streaming video for various purposes, for foot traffic updates, store coverage, and routes, delivery and location verification, special events, etc.

14. A comprehensive method of advertising via mobile platforms, the method comprising the following steps:
a) providing adequate compensation to the person associated with the platform;
b) providing an onboard or portable platform location device, such as a GPS device.

15. A comprehensive method of advertising via mobile platforms, the method comprising the following steps:
a) providing adequate compensation to the person associated with the platform;
b) providing the Internet, Intranet, or other networking system as a communication and/or business interface between the ad agency, etc. and platform persons.

16. A comprehensive system regarding the business methods of providing advertising media via mobile platforms, the methods comprising the following steps:
a) providing the Internet, Intranet, peer-to-peer or other networking system as a communication and/or business interface between the ad agency and/or other administrative organization and the platform persons;
b) providing adequate compensation to the persons associated with the platforms.
